(19) United States
(12) Patent Application Publication
(10) Pub. No.: US 2025/0238878 A1
(43) Pub. Date: Jul. 24, 2025

(54) ISSUE IDENTIFICATION SYSTEMS, PROCESSES AND METHODS

(71) Applicant: TRUE ANALYTICS, LLC, Brooklyn, NY (US)

(72) Inventor: Daniel O'CONNELL, Minnetonka, MN (US)

(73) Assignee: TRUE ANALYTICS, LLC., Brooklyn, NY (US)

(21) Appl. No.: 19/033,271

(22) Filed: Jan. 21, 2025

Related U.S. Application Data
(60) Provisional application No. 63/623,432, filed on Jan. 22, 2024.

(51) Int. Cl. G06Q 50/04; G06Q 10/0631

(52) U.S. Cl. CPC G06Q 50/04; G06Q 10/06315

(57) ABSTRACT

A process for identifying improvements in a plant may include obtaining operating data associated with multiple devices in the plant. The process may also include performing at least one calculation relative to the operating data using one or more algorithms. The process may further include normalizing the at least one calculation to obtain normalized values. The process may also include identifying a first device of the plurality of devices that has an issue using the normalized values. The process may further include presenting at least one action for a user to undertake to address the issue via a user interface.

### CROSS-REFERENCE

This U.S. Patent Application claims priority to U.S. Provisional Patent Application No. 63/623,432, titled “ISSUE IDENTIFICATION SYSTEMS, PROCESSES AND METHODS,” and filed on Jan. 22, 2024, the disclosure of which is hereby incorporated by reference in its entirety.

### TECHNICAL FIELD

This disclosure relates generally to industrial process control and automation systems. More specifically, this disclosure relates to apparatuses and methods for identifying related defects associated with manufacturing or other processes occurring in a plant.

### BACKGROUND

Unless otherwise indicated herein, the materials described herein are not prior art to the claims in the present application and are not admitted to be prior art by inclusion in this section.

Plants or enterprises often include a collection of machines used in industry for which the plant or enterprise is associated. Plants can include, for example, a factory where a product or power is made. Many plants operate continuously. When a plant operates continuously, the plant attempts to produce, for example, a product or substance 24 hours a day, 7 days per week without a break in operation. These plants attempt to run one or more processes the same way constantly.

Some plants operate in batches. Batch productions may be processes which may be typically repetitively performed by a plant to product identical outputs or products. Thus, when a plant operates in a batch production, the batch production may be configured to run according to a protocol for a period of time. Once the time criteria is met or the batch is completed, the batch production may be terminated. A plant may then repeat that batch step over and over (e.g., repetitively), or the plant may start a new and/or different batch. Each batch can have a batch group which may be groupings of operating parameters that work on a specific batch. If batches are producing the same output (e.g., same object) or have the same goals or objectives, the batches may be grouped by type. Batch groups can be operated by a single command. Thus, a batch group of devices can be used to produce one or more batch types. Within a batch group and a batch type, a specific instance of that batch may be a batch event.

During batch production, a wide variety of industrial process controllers and devices can be deployed as part of the operation or industrial processes. In order to ensure that the batch production can continue to produce batches with minimal downtime of equipment and/or processes, identification of performance issues for multiple pieces of equipment associated with a batch production may be important to ensure optimal performance.

What is needed are processes, systems and methods that facilitate performance and/or issue identification for one or more pieces of equipment or processes within a plant or enterprise.

The subject matter claimed herein is not limited to implementations that solve any disadvantages or that operate only in environments such as those described above. Rather, this background is only provided to illustrate one example technology area where some implementations described in the present disclosure may be practiced.

### SUMMARY

Disclosed are processes, systems, and methods that facilitate performance and/or issue identification for one or more pieces of equipment and/or processes within a plant or enterprise. Disclosed are processes for identifying process improvements or as part of an overall process performance in a plant. The issue identification process can occur over time. The issue identification process includes, for example, obtaining one or more operating parameters and/or data from one or more pieces of equipment operating in an environment or within a plant, or between equipment or processes occurring in more than one physical plant location (e.g., where equipment or processes may be connected via the cloud).

Additional data can include, for example: data identifying the types of operating parameters; data identifying the importance of operating parameters; data identifying which operating parameters belong to the same loop; data identifying which operating parameters are ‘redundant’ measurements; data identifying operating range parameters are operational process states or shutdown process states; data identifying orderings of which time series are considered ‘upstream’ or ‘downstream’ from each other; data identifying one or more key tags, describing a purpose in the application, sub-unit, or plant (example: input, output, throughput, safety, critical, energy, quality); data identifying which operating parameters belong to one or more ‘batch groups’ from among the data; data identifying the above optional additional information by batch type instead of just by operating parameters.

During the issue identification processes a batch identification process can also be included. The batch identification process identifies a presence of one or more batch events (e.g., a batch event in one or more batch groups) by using at least one of: data identifying a start time and/or end time for one or more batch types; data specifying a set of preferred operating parameter values for one or more operating parameters; data specifying a preferred archetype for one or more operating parameters; the archetype; and/or data identifying one or more batch types for the above batch identification data. The preferred archetype can be described by aggregate approximation methods.

The batch identification process can further be configured to identify one or more batches of one or more batch types using batch identification algorithms, and can further normalize the batches. Normalization of the batches can involve at least one of time-variance or value-variance.

An analysis component configurable to perform multiple statistical calculations on at least one of the data or the identified batches during an analysis process can also be provided. Normalizing statistical calculations during the analysis process may be achievable using at least one of: one or more percentile values of the statistical calculations found from the set or subset of the data; and one or more percentile values of the statistical calculations found from the set or subset of the identified batches.

The system may be further configurable to identify, based on the normalized values obtained during the analysis process, which devices or processes in the plant may have issues of interest or issues requiring attention. The normalized values obtained during the analysis process may also be used to evaluate a length of time one or more devices or processes meets, exceeds, or fails to meet a target value or target range for a measured performance of that device or process. Once the system identifies which devices or processes have issues of interest, the system may be configurable to recommend one or more further possible restrictions or extensions for the devices or processes, and/or for the analysis or issues associated with the devices or processes.

A first possible restrictions or extension can use specific analytics or at least one or more analytics from a set of analytics. In some configurations, the normalization process can be based on similar device type or other identifying parameters. Additionally, leveraging the length of time above/below a certain normalized value, parameter or range, combinations of statistical/normalized values, and/or additional statistical calculations on the data can be used to identify if an issue has occurred. Alternatively, or additionally, the analytics can identify one or more periods of time when one or more issues of interest may have occurred. Identification of the one or more periods of time when one or more issues of interest have occurred can be achieved by aggregating multiple issues of interest and/or periods of time one or more issues of interest occurred. A mathematical adjustment can also be performed on the data favoring more recent issues of interest over less recent issues of interest and/or issues of interest for a particular device. Summarization of the statistical calculations or normalized calculations can be provided to cover periods of time (e.g., daily, weekly, bi-monthly, monthly etc.). Further normalization or aggregation processes can also be performed on the data based on similar or related statistical calculations. A regularization of uneven data resolutions can be performed to minimize information loss.

In some configurations, the system may be configurable to recommend at least one action to the user, where the action may be one or more of: an investigation step to further identify root causes of issues of interest; an improvement path to reduce or eliminate issues of interest; a prioritization of investigation steps and/or improvement paths; an estimate of the invasiveness of the investigation steps and/or improvement paths; and/or an estimate of the importance or financial impact of the investigation steps and/or improvement paths.

The disclosed systems and methods can also be configured to dynamically adjust the investigation steps or improvement paths based on multiple statistical calculations done within the analysis component. Dynamically adjusting can be performed on the same data sets or can use multiple data sets. Dynamically adjusting the analysis component based on a metric defining the importance of the input variables in question can also be performed.

In some configurations, a prioritization of issues based on a combination of one or more normalized values or the lengths of duration may be provided. A categorical severity of issues can also be provided based on a combination of one or more normalized values or the lengths of their duration.

Adjustment for different time periods of interest (e.g., ‘the most important using data over a 90-day period vs the most important using data from a year’) can also be performed. Prioritization of devices by incorporating one or more components of importance, invasiveness of investigation steps, or size of financial impacts can also be performed. A prioritization of groupings of related devices based on the summation of normalized analysis components from at least those devices.

Both the foregoing general description and the following detailed description are exemplary and explanatory only and are not restrictive of the disclosed embodiments, as claimed.

### Incorporation by Reference

All publications, patents, and patent applications mentioned in this specification are herein incorporated by reference to the same extent as if each individual publication, patent, or patent application was specifically and individually indicated to be incorporated by reference.

U.S. Pat. No. 12,019,429 issued Jun. 25, 2024 for Scalable industrial analytics platform;

U.S. Pat. No. 11,681,282 issued Jun. 20, 2023 for Systems and methods for determining relationship between defects;

U.S. Pat. No. 11,656,609 published May 23, 2023 for Detecting component degradation in industrial process plants based on loop component responsiveness;

U.S. Pat. No. 11,640,151 issued May 2, 2023 for and Automation operating and management system;

U.S. Pat. No. 10,678,195 issued Jun. 9, 2020 for Apparatus and method for identifying, visualizing, and triggering workflows from auto-suggested actions to reclaim lost benefits of model-based industrial process controllers;

U.S. Pat. No. 10,416,660 issued Sep. 17, 2019 for Discrete manufacturing hybrid cloud solution architecture;

U.S. Pat. No. 10,175,681 issued Jan. 18, 2019 for High level central plant optimization;

U.S. Pat. No. 10,026,049 issued Jul. 17, 2018 for Risk Assessment for industrial systems using big data;

U.S. Pat. No. 9,940,599 issued Apr. 10, 2018 for Systems and methods for generating solution recommendations for power plant operation;

U.S. Pat. No. 8,209,080 issued Jun. 26, 2012 for System for determining most probably cause of a problem in a plant;

U.S. Pat. No. 8,200,369 issued Jun. 12, 2012 for Use of statistical analysis in power plant performance monitoring;

U.S. Pat. No. 7,440,932 issued Oct. 21, 2008 for Method and system for automating issue resolution in manufacturing execution and material control systems;

U.S. Pat. No. 7,206,646 issued Apr. 17, 2007 for Method and apparatus for performing a function in a plant using process performance monitoring with process equipment monitoring and control;

US Publication US 2022/0269248 published Aug. 25, 2022 for Method and device for automatically determining an optimized process configuration of a process for manufacturing or processing products;

PCT Publication WO 2021/234732 published Nov. 25, 2021 for System and method for development and deployment of self-organizing cyber-physical systems for manufacturing industries; and

Kaber et al. (1997) for Out-of-the-Loop Performance Problems and the Use of Intermediate Levels of Automation for Improved Control System Functioning and Safety, Process Safety Progress 16 (3): 126-131).

### BRIEF DESCRIPTION OF THE DRAWINGS

Example implementations will be described and explained with additional specificity and detail using the accompanying drawings in which:

FIG. 1 illustrates a flow diagram for issue identification;

FIG. 2 illustrates a flow diagram for device prioritization;

FIG. 3 illustrates a flow diagram for prioritizing issues in a batch process;

FIGS. 4A and 4B illustrate an example layout of a data display, with issues organized by an analysis range and a breakdown of issues;

FIG. 5 illustrates an example of the data from FIGS. 4A and 4B, displaying the normalized scores for a specific set of statistical calculations;

FIG. 6 illustrates an example of the data from FIG. 3, displaying the normalized scores for a different set of statistical calculations from FIG. 5;

FIG. 7 illustrates an interface providing a description of information that may be included and provided to the user based on the issues available or detected.

FIG. 8 illustrates a second example of a description of information that may be included and provided to the user via a user interface based on the issues available or detected;

FIG. 9 illustrates an example of recommendations or investigation steps a user can receive via a user interface;

FIG. 10 illustrates another example of recommendations or investigation steps a user can receive via a user interface;

FIG. 11 illustrates an example of specific action steps the user can be prompted to take via a user interface given the presence of an issue;

FIG. 12 illustrates additional information the user can receive for an identified issue via a user interface;

FIG. 13 illustrates additional information the user can receive for an identified issue via a user interface;

FIG. 14 illustrates an example of a different implementation of the display of identified issues via a user interface;

FIGS. 15A and 15B illustrate a further example of a different implementation of the display of identified issues via a user interface;

FIGS. 16A and 16B illustrate a further example of a different implementation of the display of identified issues via a user interface;

FIG. 17 illustrates an example of automatically generated action items for display to a user that a user can customize;

FIG. 18 illustrates an example of selected action items provided to the user via an interface, complete with a tracking of whether changes have been implemented by a human or rejected; and

FIGS. 19A and 19B illustrate an example implementation of using prioritization of devices to identify which devices or groupings of devices may be more valuable than others to review.

### DETAILED DESCRIPTION

As will be appreciated by those skilled in the art, the processes for running a plant, batches across a plant, processes across more than one plant, and/or batches across more than one plant may not work appropriately or optimally under all scenarios. For example, if a user attempts to run an algorithm intended for continuous data on processes that are designed for batches. Prior to running an algorithm, batches and other identifying data may be identified and adjustments may be made to accommodate changes in data prior to running algorithms, which may improve the algorithm output.

The adjustments that may be made prior to running an algorithm may first include identification of batches and/or distinguishing between whether data processed by the algorithm is batch data or continuous data. To identify batches, different kinds of data might be supplied that facilitates identification of batches. The data provided may or may not identify one or more instances of a given batch in the provided data set. If data is not provided that identifies all instances of batches, one or more algorithms can be used to identify more examples. A common choice would be to use symbolic aggregate approximation, which can be used to quickly identify the most common patterns in a data. Symbolic aggregate approximation (SAX) is a time series representation method.

Three terms can be used to accommodate various ways one or more batches might appear. First, particular parts of a plant may be involved in producing certain batches. Thus, there may be groups of devices within a plant, or in communication as part of a process, which may be identified for working on certain batches performed. The devices and/or parts of a plant that are involved in producing specific batches can be viewed as batch groups. Second, more than one kind of batch can be run or performed by a given batch group. Performing more than one kind of batch within a batch group are batch types. For example, a plant operable to make pet food may run one kind of pet food through a process, then run another kind of pet food, different than the first pet food, through the same devices at a different time. Third, specific iterations of batches can be run. The specific iterations of batches may be batch events.

In an industrial setting, different fuel mixing processes or food processes can be run in batches. Thus, for example, a plant might have multiple groups of devices designed to handle different types of batches (e.g., different types of fuels or different food products).

### I. Issue Identification Systems and Methods

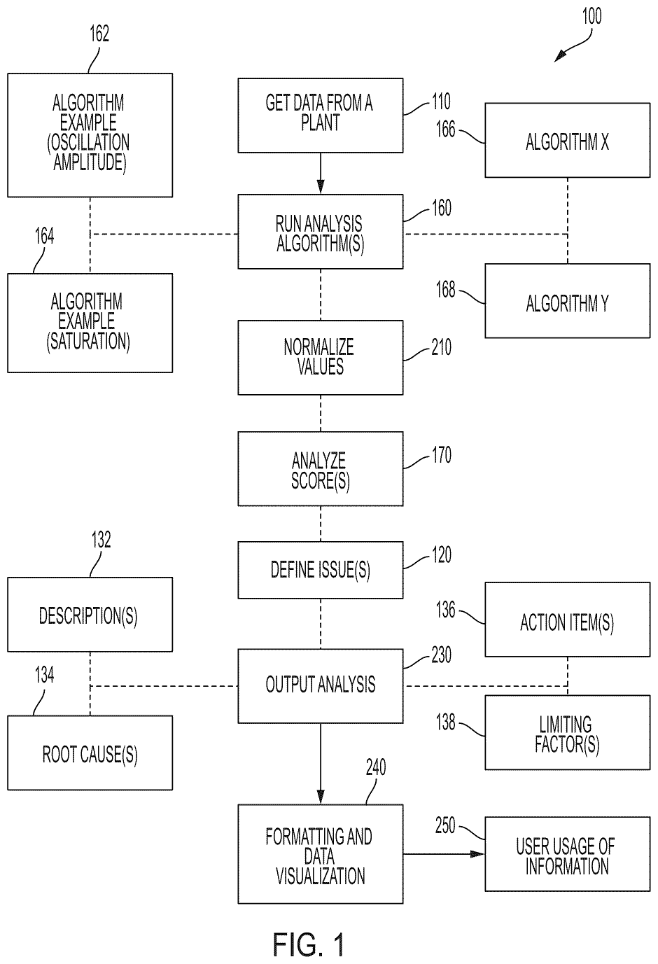

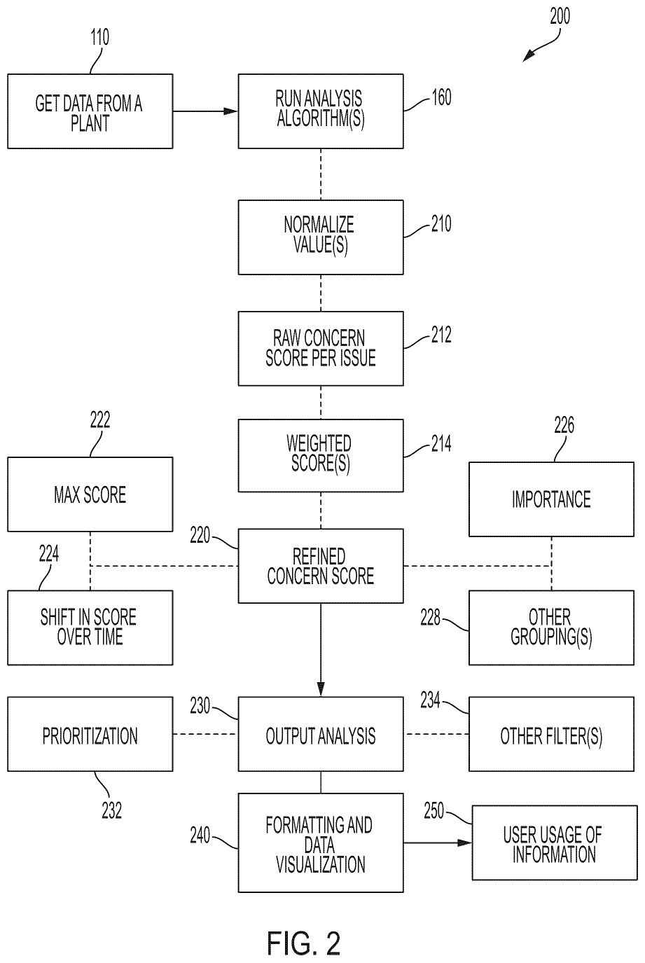

FIG. 1 illustrates a flow diagram for issue identification 100. Similar to FIG. 2, the flow may work on batch data and/or continuous data. Once the data is obtained from the plant 110 and the one or more algorithms are run 160, the data values may be normalized 210. Running the one or more algorithms 160 may include one or more algorithms, such as oscillation amplitude algorithm 162, and/or saturation algorithm 164. One or more other algorithms can also be applied, such as algorithm X 166 and/or algorithm Y 168.

Algorithm adjustments can be made. First, the batch events may be normalized, such that the batch events may be standardized. An algorithm adjustment might involve, for example, standardization by time. Standardization by time could provide that events may be stretched or condensed to have similar lengths. Alternatively, or additionally, an algorithm adjustment may involve standardization by values. Standardization by values may be a more traditional type of normalization. Standardization might occur against one or more operating parameters and/or may be achieved by subtraction of a mean of the operating parameter and then division by a standard deviation of the operating parameter to make the data unit-less. Any type of time-standardization or value-standardization can be used. Additionally, different algorithms can be used. Algorithms can also be used on normalized batch events or non-normalized batch data.

Knowing that the data is batch data instead of continuous data can be used to refine the analysis and processes. Non-normalized batch data can continue to be used as if it the non-normalized batch data is continuous, or use non-normalized batch events as the input of the algorithms to run 160.

After normalizing values 210, one or more scores may be analyzed 170 and issues may be defined 120. Thereafter, output analysis 230 can be performed followed by formatting and data visualization 240 and user usage of information 250. The output analysis 230 can include one or more of descriptions 132, root causes 134, action items 136, and/or limiting factors 138.

FIG. 2 illustrates a flow diagram for device prioritization 200. Notably, the processes in FIG. 2 can be used for both continuous data and batch data. FIG. 2 expands on the process of getting data from a plant 110 and running analysis algorithms 170 in FIG. 1. The process may include normalizing one or more values 210, providing a raw concern score per identified issue 212, weighting one or more raw scores 214, refining a concerned score 220, generating an output analysis 230, formatting and data visualization 240, and/or determining user usage information 250. The refined concern score 220 can have a max score 222 and/or a shift in the score over time 224. Additionally, the refined concern score 220 can have an importance 226 assigned. One or more other groupings 228 of the refined concern score 220 can be applied. Additionally, the output analysis 230 can be prioritized 232 and/or one or more other filters 234 can be applied.

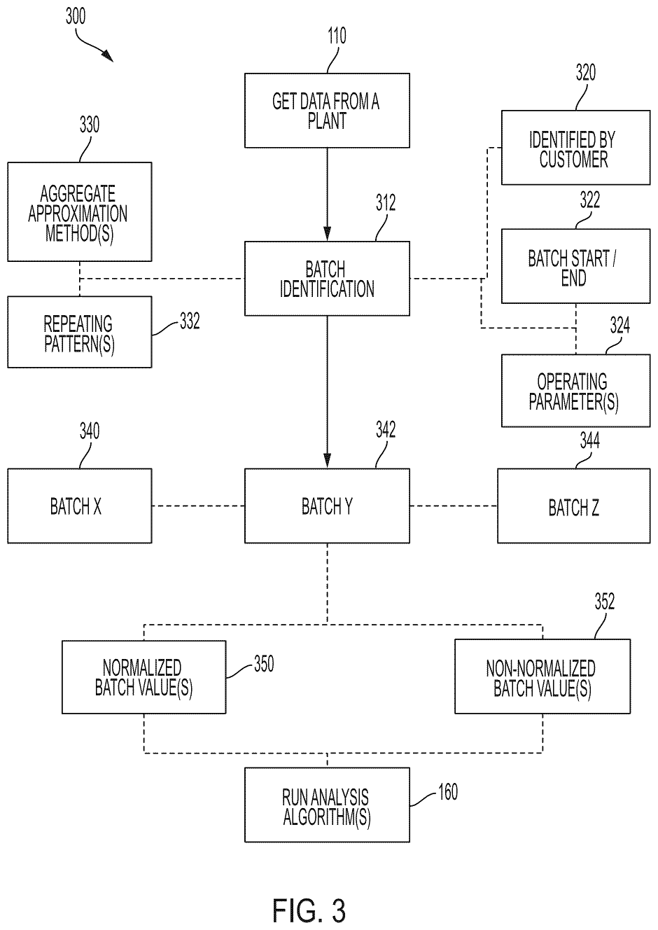

FIG. 3 illustrates a flow diagram for prioritizing issues 300 that might occur for one or more processes within a plant and/or between connected devices performing a batch. The first step of the prioritization process may be to obtain data from a plant 110. During the process of obtaining data from the plant 110, the data obtained may be, for example, one of: (1) the data obtained can be from the same operating parameters as previous uses of the methodology, but over a different set of time periods and/or (2) the data may include overlapping sections with prior uses of the methodology in a plant.

In an example, during the process of obtaining data from the plant 110, the data obtained may be historical operating parameters for the plant. These parameters may relate to a small section of the plant, such as those that handle the operation of a particular step of a process, or the entire plant.

In an extension of the issue prioritization process, identifying which time-series belongs to an identified batch group for the data can also be provided. For example, a grouping of devices in a plant environment could be configurable to handle different batch processes (e.g., one device in the plant environment produces one or more batches of a gas and another device, different from a first device, in the plant environment produces one or more batches of a liquid). An optional mechanism can be provided to separate items that do not produce related batches or related outcomes (e.g., separating gas production from liquid production). Separating items that do not produce related batches or outcomes could also be handled by running the disclosed methodology individually on groupings of batches, since there is no restriction on what the time series are or which time series are in a data set for the method.

Once data is obtained from the plant 110, the one or more batches in the obtained data set(s) may be identified (batch identification) 312. Identification of data in the data set(s) can include one or more of each of aggregating approximation method(s) 330, identifying repeating pattern(s) 332, identifying data by customer 320, identifying a batch start and a batch end 322, and/or operating parameter(s) 324. As will be appreciated by those skilled in the art, data can include operating ranges of one or more devices that identify different batches.

Once a time series is obtained that are working with batches, sections of some data that may be repeating and/or unrelated can be identified (e.g., the same mixing process can be performed to make a certain fuel(s) over and over or the same devices and data to operate a different mixing process that makes a different set of fuel(s)). In either case, where one or more batches start and end may be identified. Alternatively, or additionally, a determination may be made whether the batches may be treated as the same batch type (e.g., the same fuel produced over and over) or different batch types (e.g., a first fuel produced and then a completely different fuel produced).

Suitable methodologies usable to identify batches may include, for example, specifying a start time and an end time of one or more batch types. An additional methodology may include specifying one or more sets of preferred operating parameter values for one or more operating parameters that may be used in the batch process. The parameter values may have units or may be unit-less. For example, unit-less values can include a shape and/or time which may be considered. Where units are available for the parameter values, exact values for the data is provided. Units may also be specified with or without batch types.

An archetype (or set of archetypes) can also be provided in the form of aggregate approximation methods. The archetype can be provided piecewise or symbolic. One or more algorithms can be used to identify archetypes whether examples are provided or no examples are provided (for example, using aggregate aggregation methods). If no batch information is supplied, symbolic aggregation approximation can be used to identify the most common repeating patterns. Alternatively, if an example batch or batches are supplied, a search can be conducted to identify the data that most closely matches example batch or batches.

Persons of skill in the art will appreciate that there may be other ways to identify batches in addition to the aggregate approximation methods using the data supplied above. The batch identification methods may be run automatically or shown or reviewed by a user for confirmation/modification.

Certain data provided in the identification component could be handled in the data step. If the data processing step is applied to batch groups one at a time and the data processing steps are performed over the times where batches exist, the result may be a functionally identical result. As will be appreciated by those skilled in the art, all of the data from a plant does not need to be used during the data processing step. Moreover, the time ranges do not need to be specified during the data processing step. As will be appreciated, by providing that all data may not be required and/or the time ranges may not be required, processes may be easier to perform automatically. Once batches are identified, the identified batches may or may not be normalized based on time variance (e.g., stretching or condensing the data in a batch on a time-basis to achieve uniformity) or based on values (e.g., traditional normalization, one approach being subtract the mean of the data and divide by the standard deviation). Some algorithms in the analysis component may also be run on the data from normalized batches, while some algorithms may be run on the data from non-normalized batches.

An output of the batch identification 312 can be one or more batches, for example batch X 340, batch Y 342, and/or batch Z 344, as shown in FIG. 3. For example, once a time series for one or more batches is obtained, there may be sections of some data from the one or more batches that may repeat and/or that may be unrelated (e.g., the same mixing process to make a certain fuel(s) can be performed over and over; or the same device(s) and/or data can be used to operate a different mixing process that makes a different set of fuel(s)). In either case, identifying where one or more batches start and end 322 and if the batch may be treated as the same ‘batch type’ (e.g., fuels produced over and over) or different batch types (a first fuel produced, then a completely different fuel produced).

Methodologies that can be used to identify batches include, for example: 1) specify a start time and/or an end time of one or more batch types; 2) specify one or more sets of preferred operating parameter values for one or more operating parameters. These operating parameter values may be unit-less. 3) Where the operating parameter values are unit-less and the shape and/or time are considered. 4) Where the operating parameter values have units the exact value of the units matter. The operating parameter values may be specified with batch types or without batch types. 5) Supply an archetype (or set of archetypes) in the form of aggregate approximation methods (most commonly piecewise or symbolic). 6) Provide examples or no examples, using one or more algorithms to identify the examples. For example, using aggregate approximation methods 330. For example, if no batch information is supplied, using symbolic aggregation approximation to identify common repeating patterns and/or rank common repeating patterns by occurrence. Alternatively, if an example batch or batches are supplied, a search can be conducted to identify the data that most closely matches those examples. There may be other ways to identify batches besides aggregate approximation methods using supplied data. These identified batches may be run automatically or shown or reviewed by a user for confirmation and/or modification.

A subset of data can be provided in an identification component and could be processed in the data step. However, the data can also be split and grouped with other approaches. If the disclosed processes are applied to batch groups one at a time and applied to batch groups over the times where batches exist could be functionally identical. As noted above, some or all of the data received from a plant can be used and/or time ranges need not be provided for the processes to function. Once batches are identified, the data from the batches may or may not be normalized based on time variance (e.g., stretching or condensing the data on a time-basis to be uniform) or based on values (e.g., traditional normalization, one approach being subtract the mean of the data and divide by the standard deviation). Some algorithms in the analysis component may be run on the normalized batches, some may be run on the non-normalized batches. During the process, the one or more batches may be normalized 350 or non-normalized 352, after which one or more analysis algorithms may be run 170 on the normalized batch value(s) 350 and/or the non-normalized batch value(s) 352.

One or more analysis algorithms 170 can be run using the normalized batch values 350 or non-normalized batch values 352. By normalizing batches, the algorithm may be run on distinctly new outputs, even when the same functions may be used. The algorithms can be run on both normalized/un-normalized data and then new algorithms may be run on only a subset of the data.

Processing batch data in the same manner as continuous data may not achieve the usable data when the process is used for continuous data. Processing batch data, therefore, may be benefitted by the application of different instructions.

The one or more algorithms may use one or more batch events, batch types, or batch groups as algorithm inputs. The algorithm can also be applied to continuous approaches on batch data or can be treat batch data as continuous data.

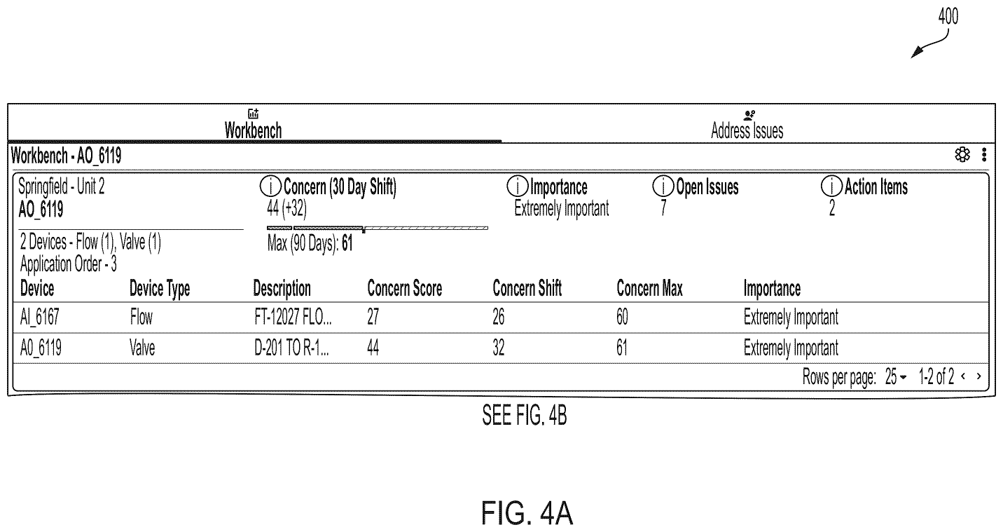

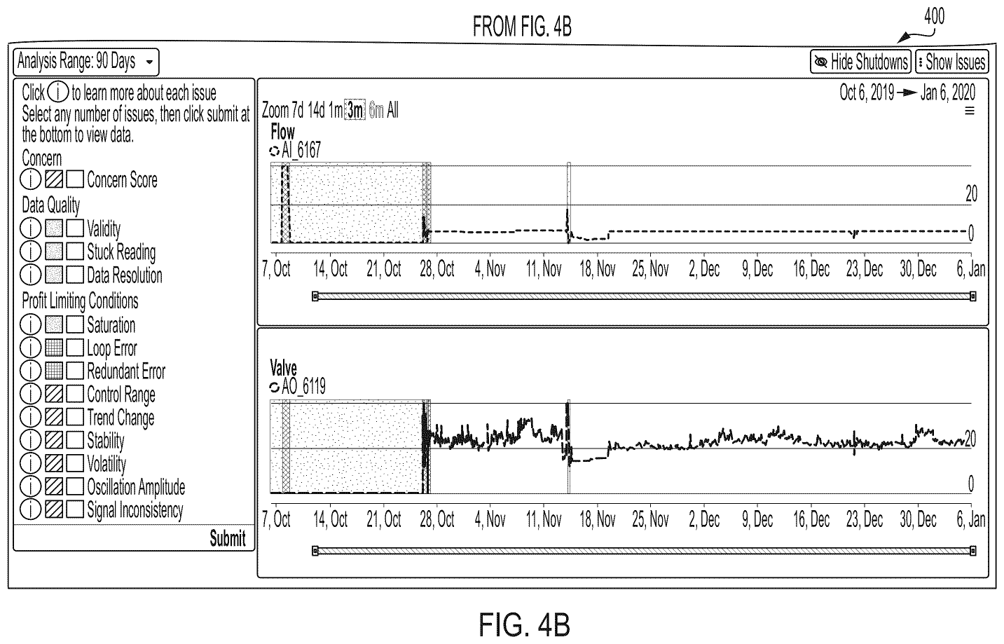

FIGS. 4A and 4B illustrate an example layout of a data display 400 on a user interface. The data display 400 may be generated to display identified issues organized by an analysis range (in this case, an analysis range that provides a 90 day review) and a breakdown of the identified issues. Checkboxes can be provided that may be color coded to indicate different levels of priority. For example, red may indicate a high priority. A workbench summary may be visible that may identify, for example, concern, importance, open issues and/or action items.

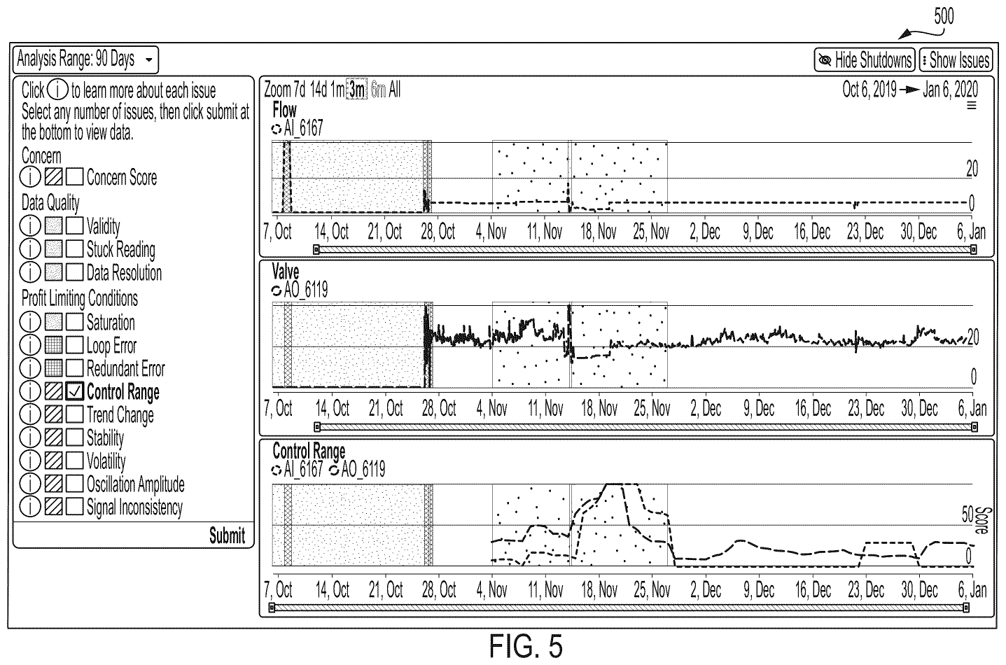

FIG. 5 illustrates an example data display 500 on a user interface using the same data displayed in FIGS. 4A and 4B. Normalized scores for a specific set of statistical calculations (control range) are illustrated. The region with unusual performance is illustrated as highlighted or emphasized, with those regions determined both by the normalized values and/or the duration of the incident. In some instances, the highlighted/emphasized region may indicate a time range in which processes may be shutdown (e.g., with respect to flow, valve, and/or control range as illustrated in FIG. 5) and/or when algorithms may not be processing. Alternatively, the unusual performance can be emphasized by, for example, placing the information in a box or otherwise marked to emphasize importance. A normalized score may have a normalized range of 0-10, which may relate to normalized scores of other devices and data. In other implementations, the normalized range could take on any number range (ex: 1-5, 0-100, etc.).

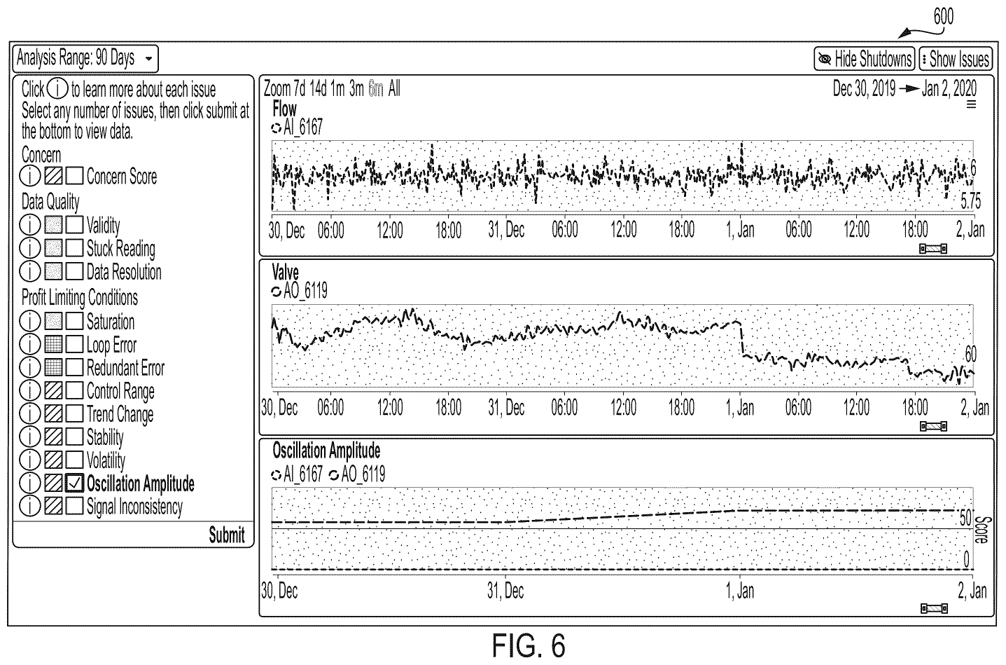

FIG. 6 illustrates an example data display 600 on a user interface using the same data displayed in FIG. 3, this time displaying normalized scores for a different set of statistical calculations from FIG. 5 (oscillation amplitude). The region with unusual performance is highlighted or emphasized, with those regions determined both by the normalized values and/or the duration of the incident.

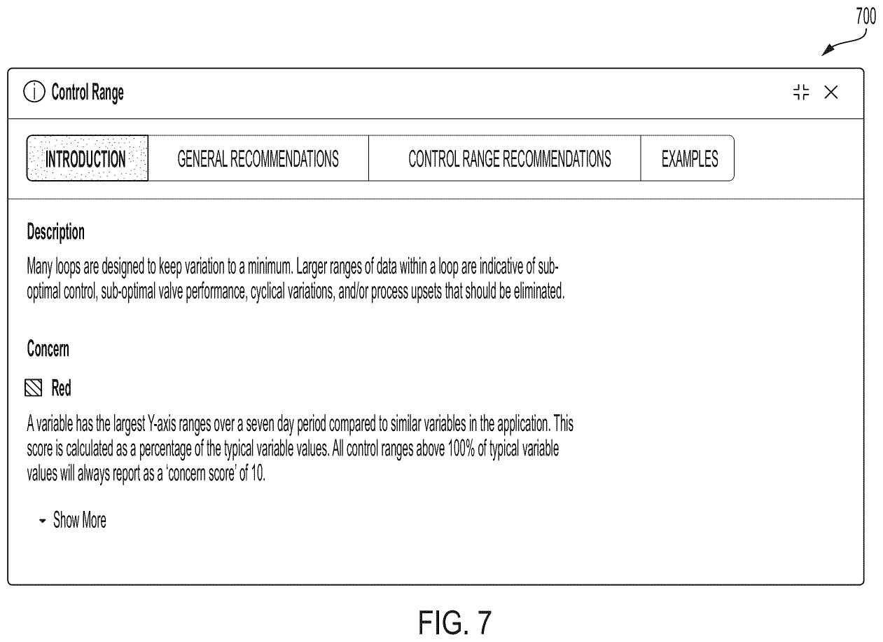

FIG. 7 illustrates an information display 700 on a user interface providing a description of information that may be included and provided to a user based on available or detected issues.

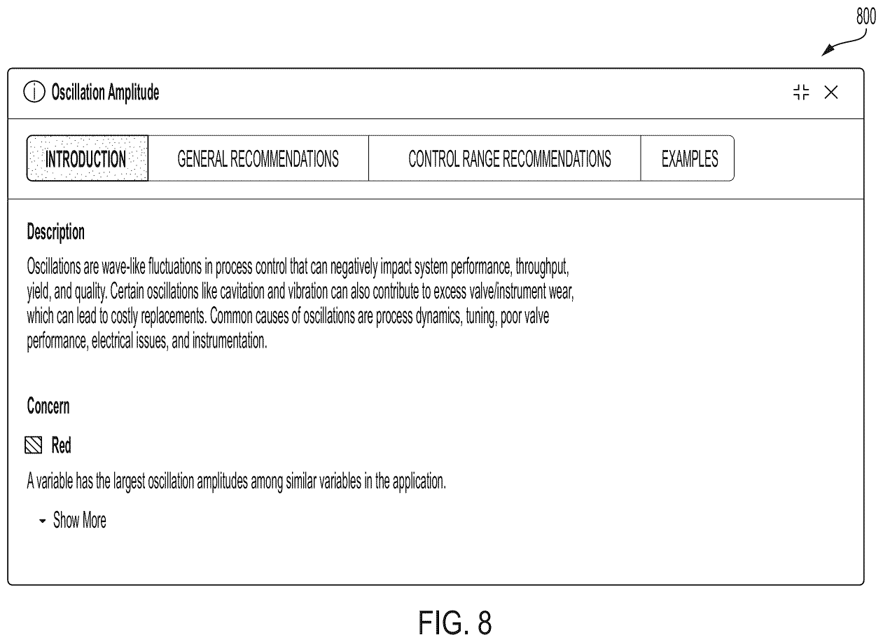

FIG. 8 illustrates an information display 800 on a user interface with a description of information that may be included and provided to the user based on available or detected issues.

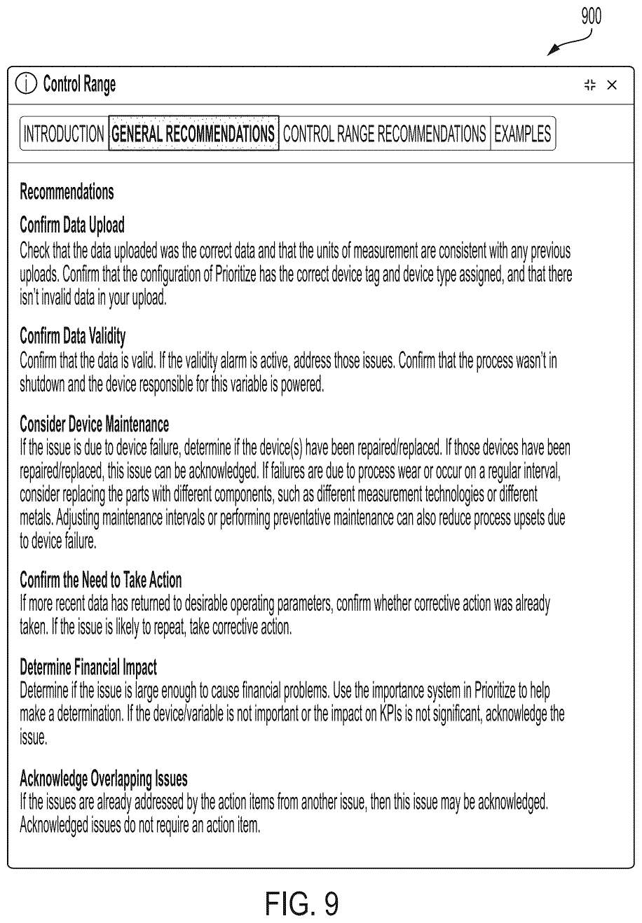

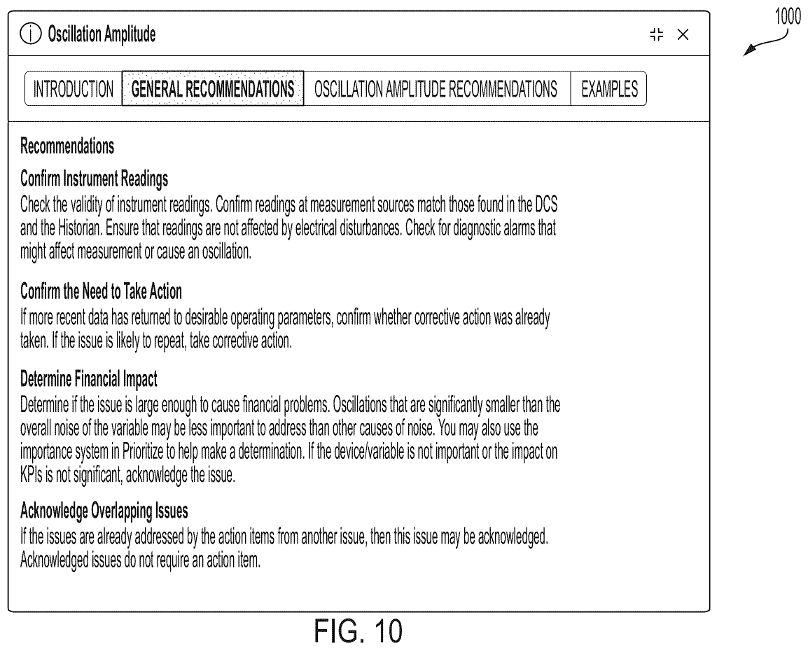

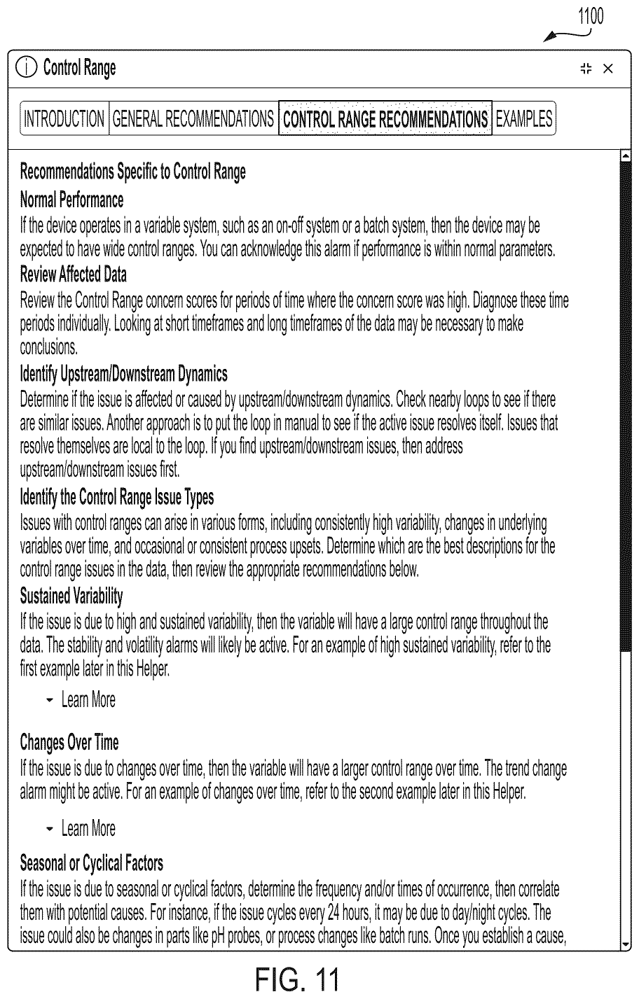

FIG. 9 illustrates an information display 900 on a user interface with exemplar recommendations and/or investigative steps a user can undertake to address available or detected issues. As will be appreciated by those skilled in the art, the descriptions in FIG. 9 are different than the specific recommendations for an issue (FIG. 11) and different from the general recommendations provided for another issue (FIG. 10). This can be achieved on a static or dynamic basis, depending on implementation.

FIG. 10 illustrates an information display 1000 on a user interface with another example of recommendations or investigation steps a user can receive. Note that the descriptions general recommendations that are different than any specific recommendations that might be made for an issue. The specific recommendations may be locatable in another tab in the menu. Additionally, the specific recommendations and different from the general recommendations provided such as shown in FIG. 9. The changes in recommendations can be achieved on a static or dynamic basis, depending on implementation.

FIG. 11 illustrates an information display 1100 on a user interface with an example of specific action steps the user can take given the presence of an issue (e.g., control range). This is an example of a static implementation. Available recommendations may be reduced based on additional statistical information from the analysis step.

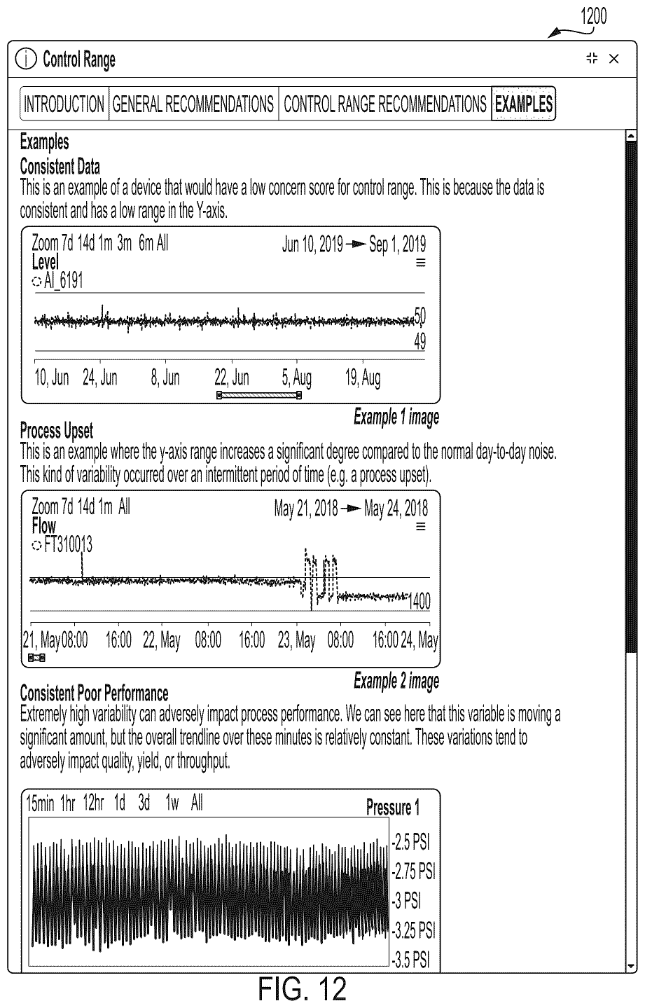

FIG. 12 illustrates an information display 1200 on a user interface with additional information or guidance a user can receive for an available or detected issue. The information display 1200 may provide a description of potential data patterns the user can see based on the available or detected issue. Including the data patterns based on the analysis steps may reduce training and/or may improve consistency of the output.

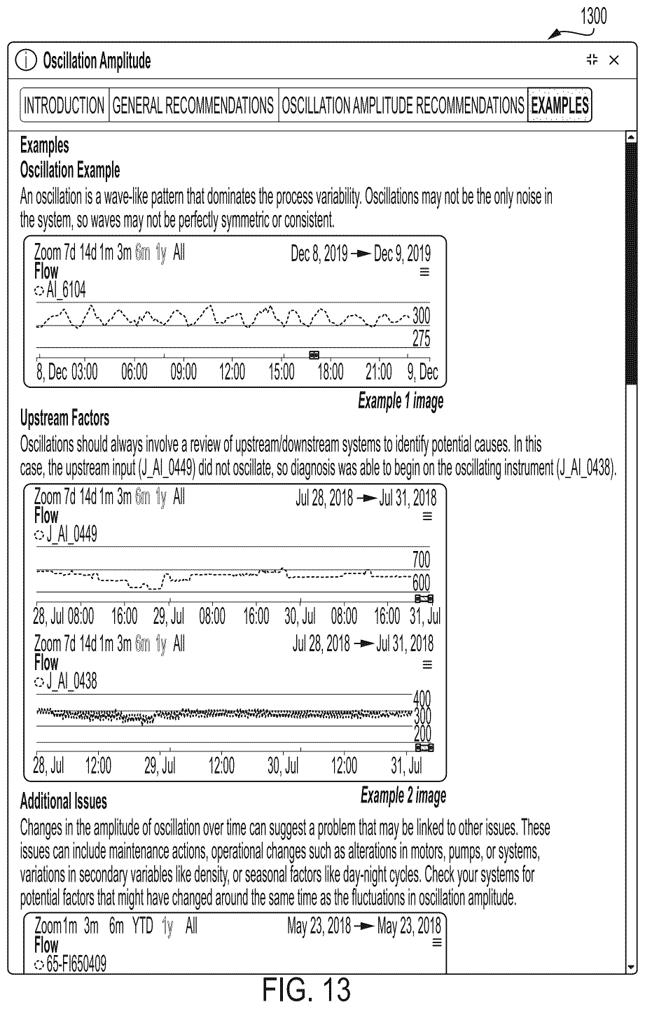

FIG. 13 illustrates an information display 1300 on a user interface with additional information a user can receive on an available or detected issue. The additional information may illustrate and/or describe potential data patterns for the user based on the available or detected issue. Including the information based on the analysis steps found may reduce training and/or may improve consistency of the output.

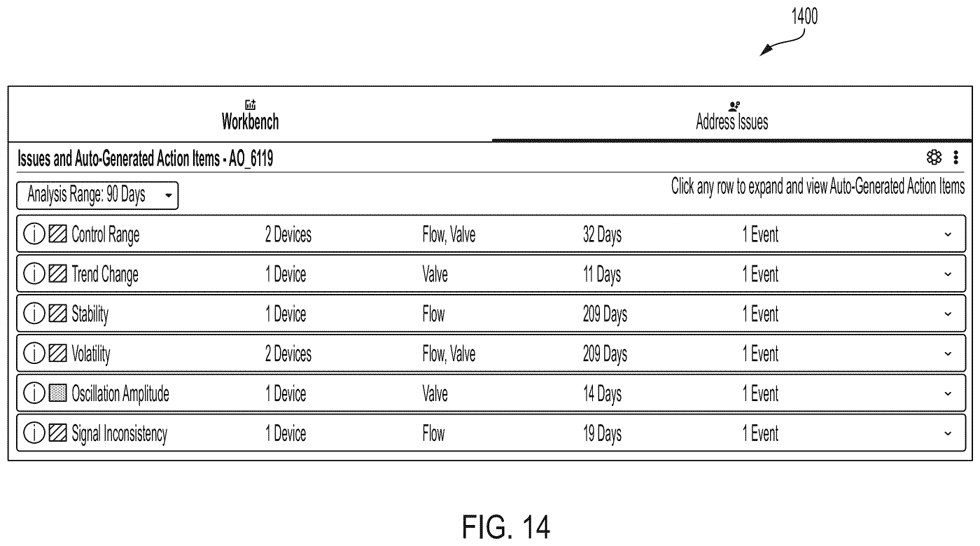

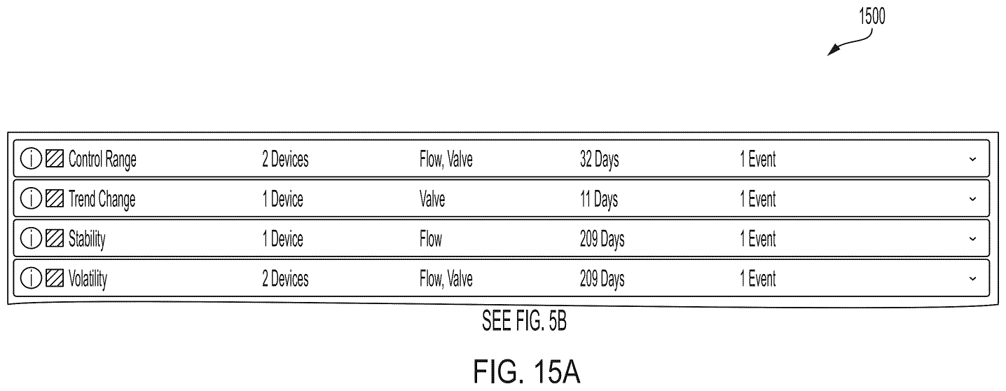

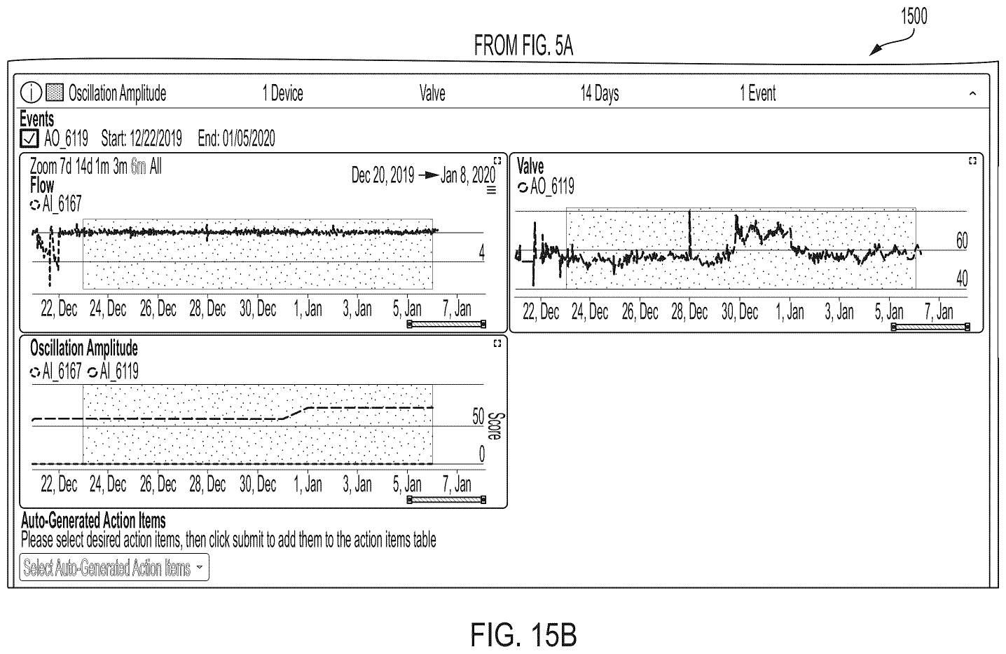

FIG. 14 illustrates an information display 1400 on a user interface with an example of another display of available or detected issues. In this case, a list of available or detected issues may be displayed, and information relevant to the available or detected issues may be available for viewing. In some instances, the issues may be view when the issue ‘row’ is expanded, as shown in FIGS. 15-18. Issues may be prioritized based on the severity, presence of other issues, and/or other identifying information.

FIGS. 15A and 15B illustrate an information display 1500 on a user interface with a further example of a different implementation of the display of identified issues. The detected issue “oscillation amplitude” in FIG. 14 may be expanded to display relevant periods of time. The relevant periods of time may be selectable and can be configured so that the relevant data from those periods may be displayed. The displayed data may or may not include one or more devices from a grouping of devices. Auto-generated action items can be made available via a dropdown to the user.

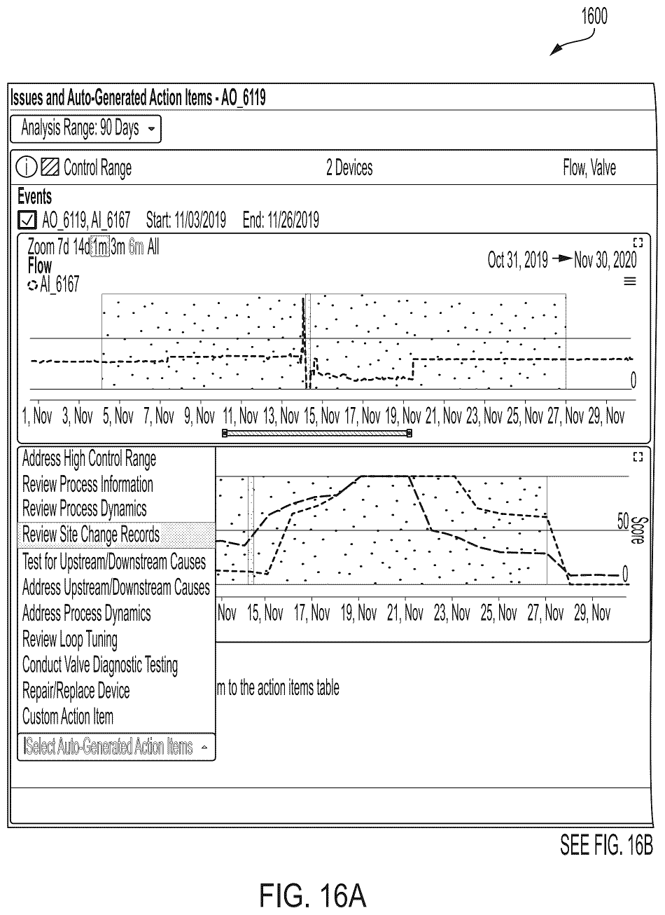

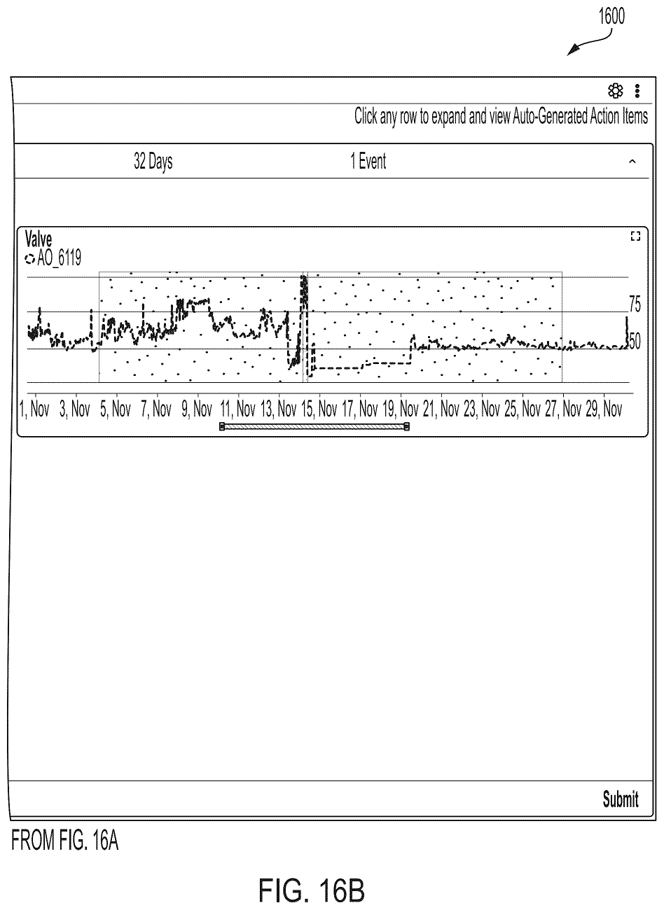

FIGS. 16A and 16B illustrate an information display 1600 on a user interface with a further example of a different implementation of the display of identified issues. The detected issue “control range” in FIG. 14 is expanded. In this implementation, relevant periods of time are selectable and only the relevant data from those periods are displayed. This may or may not include one or more devices from a grouping of devices.

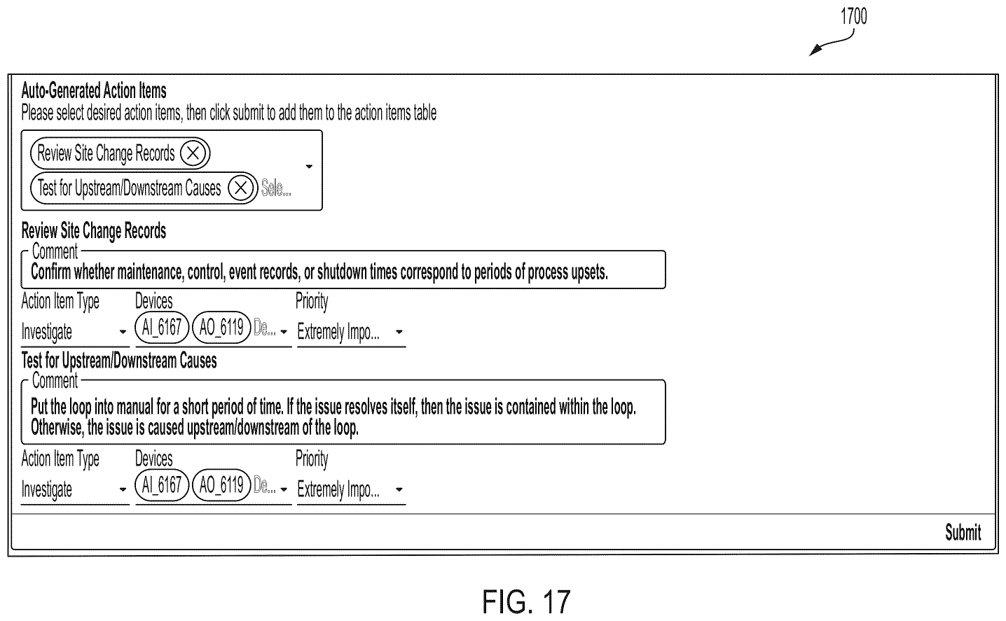

FIG. 17 illustrates an information display 1700 on a user interface with an example of automatically generated action items that a user can customize. In this case, identification of devices affected, a priority of implementation, an invasiveness of implementation, a description, and a title are all provided to the user based on the available data.

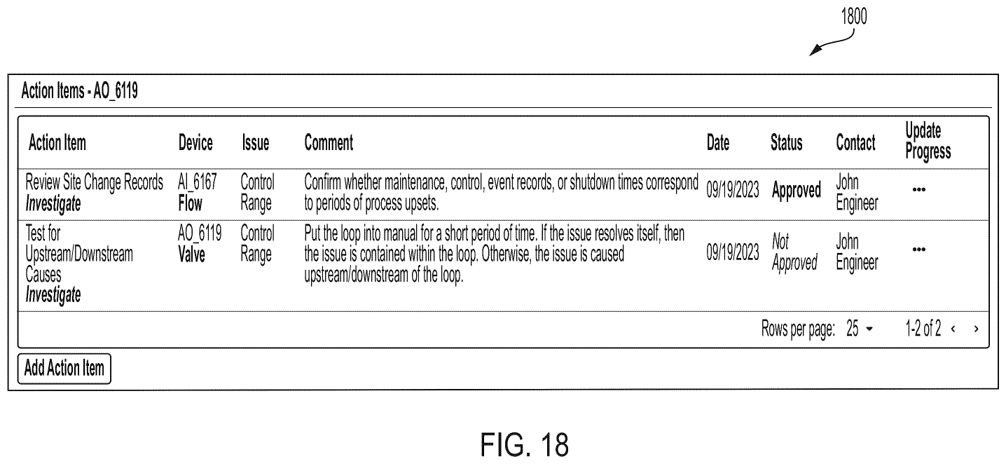

FIG. 18 illustrates an information display 1800 on a user interface with an example of selected action items provided to a user. The selected actions displayed include a tracking of whether changes have been implemented or rejected, e.g., has a user or technician reviewed and implemented the recommended change or has a user or technician reviewed and rejected the recommended change (e.g., concluded that the recommended change is not required, necessary, appropriate or no longer required, necessary, appropriate).

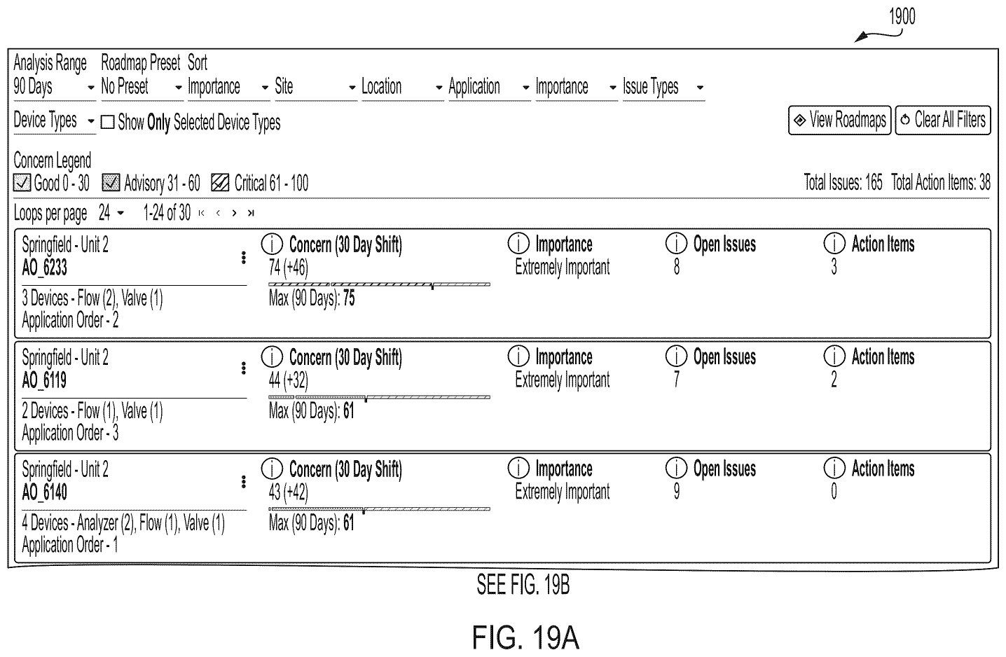

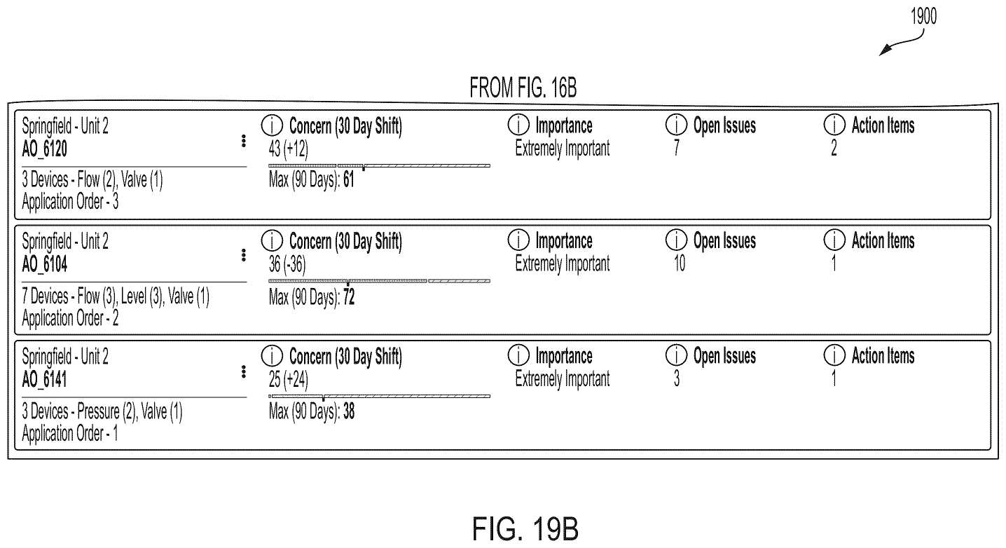

FIGS. 19A and 19B illustrate an information display 1900 on a user interface with an example implementation of that prioritizes devices to identify which device(s) or groupings of devices may be more valuable than others to review. These device review prioritizations can, for example, be based on the number of issues present, the time range of interest, the normalized scores, and/or other factors.

### II. Computing and Network Environments

As will be appreciated by those skilled in the art, data transmission from the devices can be wired and communicated to a distributed control system (DCS), a programmable logic controller (PLC), or a supervisory control and data acquisition system (SCADA) with historical data to that DCS/PLC/SCADA stored in a historian. A common approach is to extract data from the historian or a similar data repository. Data extraction can be, for example, via a direct connection or an export (e.g., a comma separated value (CSV) or Excel (or other spreadsheet) file (XLS). Additionally, there may be relevant data in other locations such as enterprise resource planning (ERP) systems like SAP ERP (developed by SAP®) which may be supplied to and evaluated in the disclosed processes.

The wired and/or wireless communication methods of the devices to the distributed control system(s) can be, for example, Highway Addressable Remote Transducer (HART) bi-directional communication protocol for transferring multiple signals by superimposing low-level digital signals on the, 4-20 mA signal used for standard analog signal transmission, Foundation Fieldbus protocol, Process Field Bus (PROFIBUS), etc. A direct connection to devices is also possible with no distributed control system in between.

Many example implementations have been described in part in the above sections of this disclosure. The system operates on computer systems that can be a combination of on-premises, in the cloud (hosted externally), mobile devices, IoT sensors attached to equipment stationary or mobile such as to UAV (Unmanned Aerial Vehicles or drones) and an extensible set of third party supplied applications and devices that extend the functionality of the system. Distributed network architecture ensures network stability, redundancy and resilience built into the network. A distributed computing network built using the distributed network architecture described above can run distributed applications, for example, autonomous distributed building or device control systems, web services, secure peer to peer networking, distributed data management services, cloud storage, distributed databases, decentralized groups or companies, blockchain based distributed trading platforms, cryptographic tokens, document processing, blockchain based Turing complete virtual machines, graphics rendering, distributed blockchain based accounting systems, etc.

Multiple computing devices can be deployed in implementing the disclosed systems and methods. Computing devices include one or more: computing device processors, memories, storage devices, high-speed interfaces connecting to memory and high-speed expansion ports, and low speed interfaces connecting to low speed bus and storage device. Each of the components of the one or more computing devices can also be interconnected using various busses, and can be mounted on a common motherboard or in other manners as appropriate. Processor can process instructions for execution within computing device, including instructions stored in memory or on storage device to display graphical data for a GUI on an external input/output device, including, e.g., each computing device can include a display coupled to high speed interface. In other implementations, multiple processors and/or multiple busses can be used, as appropriate, along with multiple memories and types of memory. Also, multiple computing devices can be connected, with each device providing portions of the operations (e.g., as a server bank, a group of blade servers, or a multi-processor system).

Memories are configurable and operable to store data within computing devices. In one implementation, memory is a volatile memory unit or units. In another implementation, memory is a non-volatile memory unit or units. Memory can also be another form of computer-readable medium (e.g., a magnetic disk, optical disk or solid state disk). Memory can also be non-transitory.

Storage devices are capable of providing mass storage for computing device. In one implementation, storage device can be or contain a computer-readable medium (e.g., a floppy disk device, a hard disk device, an optical disk device, or a tape device, a flash memory or other similar solid state memory device, or an array of devices, such as devices in a storage area network or other configurations). A computer program product can be tangibly embodied in a data carrier. The computer program product also can contain instructions that, when executed, perform one or more methods (e.g., those described above.) The data carrier is a computer-or machine-readable medium, (e.g., memory, storage device, memory on processor, and the like).

High-speed controllers manage bandwidth-intensive operations for computing device, while low speed controllers manage lower bandwidth-intensive operations. Such allocation of functions is an example only. In one implementation, high-speed controller is coupled to memory, display (e.g., through a graphics processor or accelerator), and to high-speed expansion ports, which can accept various expansion cards. In the implementation, low-speed controllers are coupled to storage devices and low-speed expansion port. The low-speed expansion port, which can include various communication ports (e.g., USB, Bluetooth®, Ethernet, wireless Ethernet), can be coupled to one or more input/output devices (e.g., a keyboard, a pointing device, a scanner, or a networking device including a switch or router, e.g., through a network adapter). Computing devices can be implemented in a number of different forms, as shown in the figure. For example, computing devices can be implemented as standard server, or multiple times in a group of such servers. Computing devices can be implemented as part of rack server system. In addition or as an alternative, it can be implemented in a personal computer (e.g., laptop computer). In some examples, components from computing devices can be combined with other components in a mobile device (not shown), e.g., device. Each of such devices can contain one or more of computing devices and an entire system can be made up of multiple computing devices communicating with each other.

Computing device includes processor, memory, an input/output device (e.g., display, communication interface, and transceiver) among other components. Device also can be provided with a storage device, (e.g., a microdrive or other device) to provide additional storage. Each of the devices, processor, display, memory, communication interfaces, and transceiver, are interconnected using various buses, and several of the components can be mounted on a common motherboard or in other manners as appropriate.

A processor can execute instructions within computing device, including instructions stored in memory. The processor can be implemented as a chipset of chips that include separate and multiple analog and digital processors. The processor can provide, for example, for coordination of the other components of device, e.g., control of user interfaces, applications run by device, and wireless communication by device.

Processor can communicate with a user through control interface and display interface coupled to display. Display can be, for example, a TFT LCD (Thin-Film-Transistor Liquid Crystal Display) or an OLED (Organic Light Emitting Diode) display, or other appropriate display technology. Display interface can comprise appropriate circuitry for driving display to present graphical and other data to a user. Control interface can receive commands from a user and convert them for submission to processor. In addition, external interface can communicate with processor, so as to enable near area communication of device with other devices. External interface can provide, for example, for wired communication in some implementations, or for wireless communication in other implementations, and multiple interfaces also can be used.

Memory stores data within computing device. Memory can be implemented as one or more of a computer-readable medium or media, a volatile memory unit or units, or a non-volatile memory unit or units. Expansion memory also can be provided and connected to device through expansion interface, which can include, for example, a SIMM (Single In Line Memory Module) card interface. Such expansion memory can provide extra storage space for device, or also can store applications or other data for device. Specifically, expansion memory can include instructions to carry out or supplement the processes described above, and can include secure data also. Thus, for example, expansion memory can be provided as a security module for device, and can be programmed with instructions that permit secure use of device. In addition, secure applications can be provided through the SIMM cards, along with additional data, (e.g., placing identifying data on the SIMM card in a non-hackable manner).

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer-or machine-readable medium (e.g., memory, expansion memory, and/or memory on processor), which can be received, for example, over transceiver or external interface.

Device can communicate wirelessly through communication interface, which can include digital signal processing circuitry where necessary. Communication interface can provide for communications under various modes or protocols (e.g., GSM voice calls, SMS, EMS, or MMS messaging, CDMA, TDMA, PDC, LTE, WCDMA, CDMA2000, or GPRS, among others or any newly developed communication protocols) Such communication can occur, for example, through radio-frequency transceiver. In addition, short-range communication can occur, e.g., using a Bluetooth®, WiFi, or other such transceiver (not shown). In addition, GPS (Global Positioning System) receiver module can provide additional navigation-and location-related wireless data to device, which can be used as appropriate by applications running on a device. Sensors and modules such as cameras, microphones, compasses, accelerators (for orientation sensing), etc. may be included in the device. It will be appreciated by those skilled in the art, that the devices and systems described can communicate using many of the common and emerging internet-of-things (IoT) protocols depending on the situation and the environment. Examples of protocols include Zigbee, LoRa (wide area long range protocol), NB-IoT (narrow band IoT), WiFi, BLE (blue tooth low energy).

Device also can communicate audibly using audio codec, which can receive spoken data from a user and convert it to usable digital data. Audio codec can likewise generate audible sound for a user, (e.g., through a speaker in a handset of device). Such sound can include sound from voice telephone calls, can include recorded sound (e.g., voice messages, music files, and the like) and also can include sound generated by applications operating on device.

Computing device can be implemented in a number of different forms, as shown in the figure. For example, it can be implemented as cellular telephone. It also can be implemented as part of smartphone, tablet, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. The programs can use one or more algorithms. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures. Components of the system can be distributed by short, medium, and long distances depending on the location of the target under measurement. In some configurations the devices, such as measurement devices, operate asynchronously and capture data locally and then transit/retransmit when a signal is detected.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that any claims presented define the scope of the invention and that methods and structures within the scope of these claims and their equivalents be covered thereby.

What is claimed is:

1. A process for identifying improvements in a plant, comprising:
obtaining operating data associated with a plurality of devices in the plant;
performing, using one or more algorithms, at least one calculation relative to the operating data;
normalizing the at least one calculation to obtain normalized values;
identifying, using the normalized values, a first device of the plurality of devices that has an issue; and
presenting, via a user interface, at least one action for a user to undertake to address the issue.

2. The process of claim 1, further comprising:
identifying one or more batch events using the operating data; and
obtaining additional data associated with the operating data, wherein the at least one calculation is performed relative to the operating data, the additional data, and the one or more batch events.

3. The process of claim 2, wherein the additional data is one or more of: a type of the operating data, an importance of the operating data, an identification of redundancies in the operating data, an identification of a range for the operating data associated with an operational state, an identification of a range for the operating data associated with an shutdown state, a purpose associated with the plurality of devices, and a purpose associated with the plant.

4. The process of claim 2, wherein the batch events are arranged in one or more batch groups.

5. The process of claim 4, wherein the arrangement of the batch events into the one or more batch groups is based on at least one of:
a start time associated with the batch events;
an end time associated with the batch events;
a combination of the start time and the end time;
an adherence of the operating data to a set of preferred operating data; and
an adherence of the operating data to a preferred archetype, where the preferred archetype is described by an aggregate approximation method.

6. The process of claim 2, wherein normalizing the at least one calculation comprises using one or more percentile values of the at least one calculations obtained from the one or more batch events.

7. The process of claim 2, wherein the one or more batch events are normalized on a time basis.

8. The process of claim 2, wherein the one or more batch events are normalized on a value basis.

9. The process of claim 1, wherein normalizing the at least one calculation comprises using one or more percentile values of the at least one calculations obtained from the operating data.

10. The process of claim 1, wherein the identifying the issue is further determined based on a length of time which the normalized values satisfy a threshold value.

11. The process of claim 1, wherein the at least one action comprises one or more of:
one or more investigation steps to identify a root cause of the issue;
one or more improvement paths for the user to reduce an effect associated with the issue;
a prioritization of the one or more investigation steps;
a prioritization of the one or more improvement paths;
a first estimate of an invasiveness of the one or more investigation steps on the plant or the plurality of devices;
a second estimate of the invasiveness of the one or more improvement paths on the plant or the plurality of devices;
a third estimate of a financial impact of the one or more investigation steps on the plant or the plurality of devices; and
a fourth estimate of the financial impact of the one or more improvement paths on the plant or the plurality of devices.

12. A system, comprising:
a plurality of devices in a plant;
one or more sensors configured to obtain operating data associated with the plurality of devices; and
a computing device processor configured to:
perform, using one or more algorithms, at least one calculation relative to the operating data;
normalize the at least one calculation to obtain normalized values;
identify, using the normalized values, a first device of the plurality of devices that has an issue; and
present, via a user interface, at least one action for a user to undertake to address the issue.

13. The system of claim 12, wherein the computing device processor is further configured to dynamically adjust the at least one action based on additional calculations performed on additionally obtained operating data.

14. The system of claim 12, wherein the computing device processor is further configured to obtain additional data associated with the operating data, wherein the at least one calculation is performed relative to the operating data and the additional data.

15. The system of claim 14, wherein the additional data is one or more of: a type of the operating data, an importance of the operating data, an identification of redundancies in the operating data, an identification of a range for the operating data associated with an operational state, an identification of a range for the operating data associated with an shutdown state, a purpose associated with the plurality of devices, and a purpose associated with the plant.

16. The system of claim 12, wherein the computing device processor is further configured to:
identify one or more batch events using the operating data; and
perform the at least one calculation relative to the operating data and the one or more batch events.

17. The system of claim 16, wherein the batch events are arranged in one or more batch groups, and wherein the arrangement of the batch events into the one or more batch groups is based on at least one of:
a start time associated with the batch events;
an end time associated with the batch events;
a combination of the start time and the end time;
an adherence of the operating data to a set of preferred operating data; and
an adherence of the operating data to a preferred archetype, where the preferred archetype is described by an aggregate approximation method.

18. The system of claim 12, wherein normalizing the at least one calculation comprises using one or more percentile values of the at least one calculations obtained from the operating data.

19. The system of claim 12, wherein the one or more batch events are normalized on a time basis or are normalized on a value basis.

20. The system of claim 12, wherein the at least one action comprises one or more of:
one or more investigation steps to identify a root cause of the issue;
one or more improvement paths for the user to reduce an effect associated with the issue;
a prioritization of the one or more investigation steps;
a prioritization of the one or more improvement paths;
a first estimate of an invasiveness of the one or more investigation steps on the plant or the plurality of devices;
a second estimate of the invasiveness of the one or more improvement paths on the plant or the plurality of devices;
a third estimate of a financial impact of the one or more investigation steps on the plant or the plurality of devices; and
a fourth estimate of the financial impact of the one or more improvement paths on the plant or the plurality of devices.
